(19) United States
(12) Patent Application Publication
(10) Pub. No.: US 2010/0089014 A1
(43) Pub. Date: Apr. 15, 2010

(54) CYCLONIC SEPARATION DEVICE FOR VACUUM CLEANER

(75) Inventor: Liqun Zhou, Changzhou (CN)

Correspondence Address: BIRCH STEWART KOLASCH & BIRCH, PO BOX 747, FALLS CHURCH, VA, 22040-0747, US

(73) Assignee: Changzhou Shinri Household Appliance Manufacturing Co., Ltd., Changzhou (CN)

(21) Appl. No.: 12/252,103

(22) Filed: Oct. 15, 2008

(51) Int. Cl. B04C 5/24; B04C 5/04

(52) U.S. Cl. 55/322

(57) ABSTRACT

It is provided in the present invention with a cyclonic separation device for vacuum cleaner comprising a external barrel having a main wind inlet and a main wind outlet; a primary separator and a secondary separator in communication with each other both of which are located in the external barrel, and the primary separator is connected to the main wind inlet when the secondary separator is connected to the main wind outlet. Both filter and cyclonic separators are integrated in present invention: cyclonic filter device works as the primary separator and cyclonic separation device works as the secondary separator; which increases separation efficiency and reduces the volume of whole machine.

### FIELD OF THE INVENTION

The present invention relates to a cyclonic separation device for vacuum cleaner.

### BACKGROUND OF THE INVENTION

It is well known that cyclonic separation devices have been widely used in different vacuum cleaners. The common cyclonic separation devices work as follows: the inlet of dust-laden airflow is mounted above the cyclone chamber, and the wind outlet (negative pressure source) is mounted on the center of the chamber top; the dust-laden airflow enters into the cyclone chamber along the tangential direction and forms cyclone caused by centrifugal force, and part of dust subsides down to bottom when the dedusted air flows upwards through the filter device, then is expelled out via the wind outlet on the top (e.g. WO98/35602).

The disadvantages of this type of cyclonic filter separation devices are as follows: although part of dust is separated by the cyclone, the airflow will likely bring the subsided dust to the upward air again; thus the upward air containing a large amount of dust will block the filter device, which requires frequent cleanings.

With the development of the cyclonic separation technique, the secondary separation devices are introduced into vacuum cleaners, which are generated by installing a second cyclonic separation device onto the wind outlet in the devices described as above, and by increasing the aperture of filter devices to pass tiny dust particles, thus to reduce the blocking of filter devices.

However, this type of devices has some common disadvantages: low efficiency of the primary cyclonic separation device and inconvenient large volume due to the extra secondary cyclonic devices.

### BRIEF SUMMARY OF THE INVENTION

The object of the present invention is to provide a cyclonic separation device for vacuum cleaner in which both filter and cyclonic separators are integrated to increase separation efficiency and reduce the volume of whole machine.

In the technical solution of the present invention, a cyclonic separation device for vacuum cleaner includes: a external barrel having a main wind inlet and a main wind outlet; a primary separator and a secondary separator in communication with each other both of which are located in the external barrel, and the primary separator is connected to the main wind inlet when the secondary separator is connected to the main wind outlet;

from the top to the bottom, the external barrel is divided into a separation chamber, a connection chamber and an out-wind chamber; and the main wind inlet is located at the lower portion of the separation chamber while main wind outlet is located on the top of the out-wind chamber;

the primary separator includes a primary cyclonic barrel located in the separation chamber, the main wind inlet is connected with the primary cyclonic barrel along its tangential direction; a primary wind outlet tube located on the top portion of the primary cyclonic barrel extends up into the connection chamber and has a primary wind outlet in the connection chamber; a conical filter barrier is located on the lower end of the primary wind outlet tube and a dust outlet in communication with a primary dust collecting barrel is located on the upper portion of the primary cyclonic barrel;

the secondary separator includes a secondary dust collecting barrel located in the separation chamber; several secondary cyclonic barrels inserted paratactically in the upper portion of the secondary dust collecting barrel; the upper portion of secondary cyclonic barrel extends into connection chamber when the middle and lower portion is located in the separation chamber; a fallen-dust outlet located in the secondary dust collecting barrel is mounted on the bottom of the secondary cyclonic barrel; a secondary wind inlet located on the top lateral of the secondary cyclonic barrel is connected to the connection chamber along the tangential direction; a secondary wind outlet tube is coaxially mounted into the secondary cyclonic barrel, the upper slit of the wind outlet tube is connected to the out-wind chamber;

the upper portion of several secondary cyclonic barrels and the primary wind outlet tube are mounted in enclosed shape in the connection chamber and thus forms a divider; the secondary wind inlet as well as the primary wind outlet are located in the divider, and all the secondary wind inlets face to the primary wind outlet;

the primary dust collecting barrel and the secondary dust collecting barrel, as well as the external barrel, share a same bottom lid; one side of the bottom lid is fixed on the side wall of the external barrel by a hinge assembly, and another side of the bottom lid is fastened to the side wall of the external barrel with a joggle assembly.

Wherein, the structures of the primary cyclonic barrel and the secondary dust collecting barrel could be various:
1. The axis of the primary cyclonic barrel is parallel to but does not superposes to the axis of the secondary dust collecting barrel as the primary cyclonic barrel is partially embedded into the secondary dust collecting barrel; the circular room between the external wall of the primary cyclonic barrel and the secondary dust collecting barrel and the internal wall of the external barrel forms the primary dust collecting barrel; several secondary cyclonic barrels distribute axisymmetricly about the line crossing the centre of the circle of the primary cyclonic barrel and the external barrel.
2. The the primary cyclonic barrel, the secondary dust collecting barrel and the external barrel share a same axis; the primary cyclonic barrel is covered within the secondary dust collecting barrel, and the room between them forms the primary dust collecting barrel; the dust outlet located on upper portion of the primary cyclonic barrel is connected with the dust outlet tube, and is in communication with the primary dust collecting barrel by passing through the secondary dust collecting barrel; several secondary cyclonic barrels are placed around a circle that centers on the axis of the secondary dust collecting barrel.
3. The primary cyclonic barrel, the secondary dust collecting barrel and the external barrel share a same axis; the primary cyclonic barrel is set centrally and the secondary dust collecting barrels are located peripherally, and the room between them forms the primary dust collecting barrel; several secondary cyclonic barrels are placed around the circle that centers on the axis of the secondary dust collecting barrel.

The advantages of the present invention are as follows:
1. Both filter and cyclonic separators are integrated in present invention: cyclonic filter device works as the primary separator and cyclonic separation device works as the secondary separator, which increases separation efficiency and reduces the volume of whole machine.
2. In present invention, the primary and secondary dust collecting barrels are set up for both of the primary and secondary separators to stop cyclone blowing out dust particles; meanwhile the primary and secondary dust collecting barrels share the same bottom lid, which makes it very convenient for users to empty the dust by simply opening the lid.
3. The rotation speed of airflow in the lower portion of downstream cyclonic separator of the present invention is slower than that in the upper portion thereof preventing dust on the bottom of the dust tank from being raised again, thereby no secondary pollution generated.

### BRIEF DESCRIPTION OF THE DRAWINGS

The invention may take form in certain structures and components, several embodiments of which will be described in detail in this specification and illustrated in the accompanying drawings. In the drawings:

FIG. 1 is a front view of the first embodiment;

FIG. 2 is a top plan view of the first embodiment;

FIG. 3 is a C-C cross sectional view of FIG. 1;

FIG. 4 is an A-A cross sectional view of FIG. 1;

FIG. 5 is a B-B cross sectional view of FIG. 1;

FIG. 6 is an exploded schematic view of the first embodiment;

FIG. 7 is a front view of the second embodiment;

FIG. 8 is a top plan view of the second embodiment;

FIG. 9 is a G-G cross sectional view of FIG. 8;

FIG. 10 is a E-E cross sectional view of FIG. 8;

FIG. 11 is an F-F cross sectional view of FIG. 7;

FIG. 12 is a front view of the third embodiment;

FIG. 13 is a top plan view of the third embodiment;

FIG. 14 is a J-J cross sectional view of FIG. 13;

FIG. 15 is an H-H cross sectional view of FIG. 12.

Wherein: 1 external barrel; 11 main wind inlet; 12 main wind outlet; 13 separation chamber; 14 connection chamber; 15 out-wind chamber; 16 divider; 17 same bottom lid; 18 one side; 19 another side; 2 primary separator; 21 primary cyclonic barrel; 22 primary wind outlet tube; 23 primary wind outlet; 24 conical filter barrier; 25 dust outlet; 26 primary dust collecting barrel; 27 dust outlet tube; 3 secondary separator; 31 secondary dust collecting barrel; 32 secondary cyclonic barrel; 33 inverted conical barrel; 34 columnar barrel; 35 fallen-dust outlet; 36 secondary wind inlet; 37 secondary wind outlet tube; 4 hinge assembly; 5 joggle assembly.

### DESCRIPTION OF THE PREFERRED EMBODIMENTS

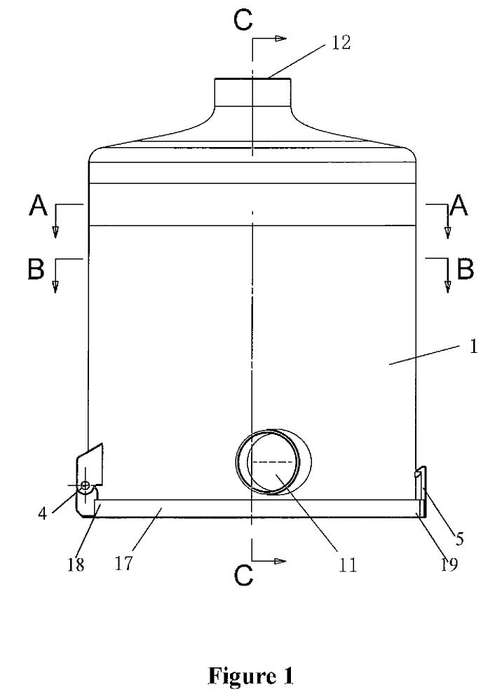

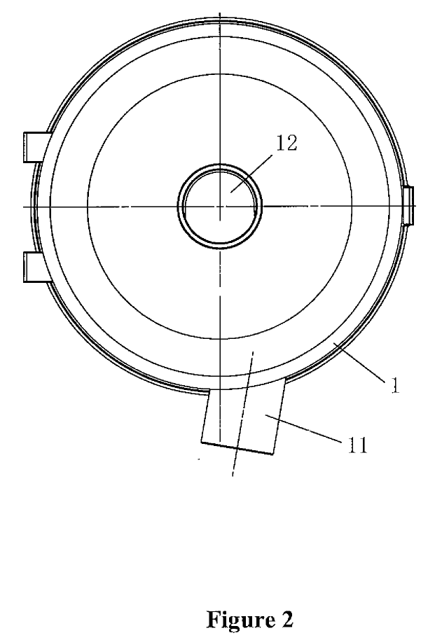

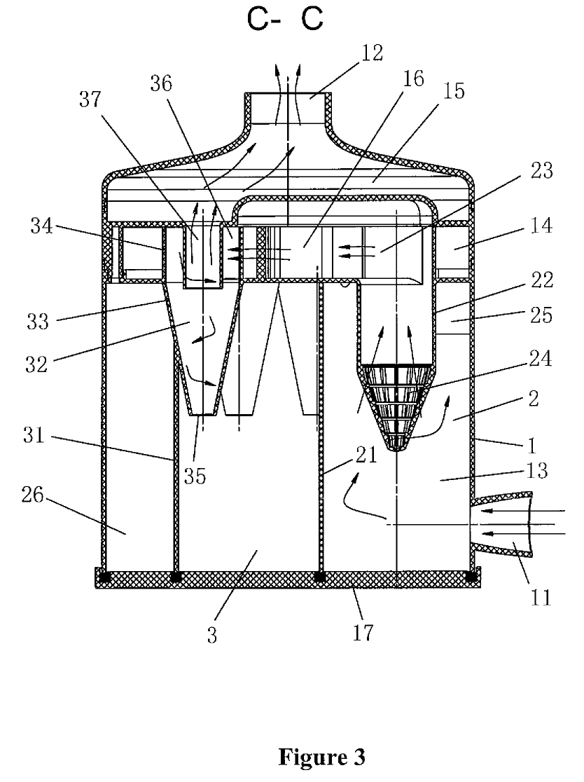

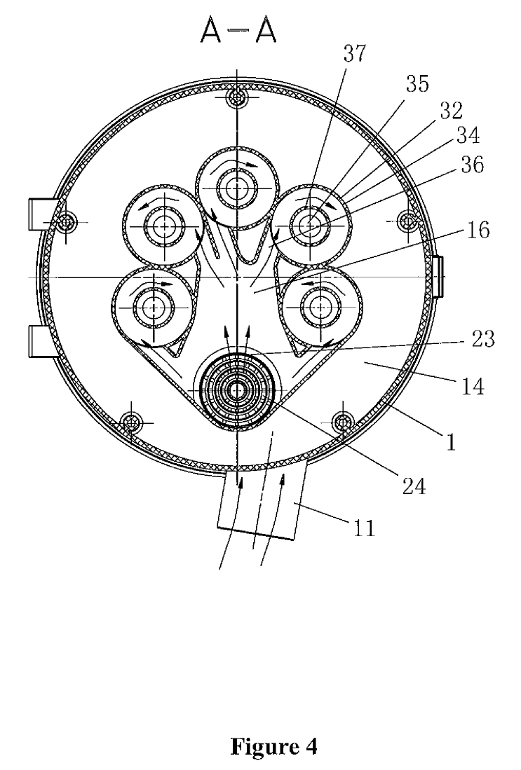

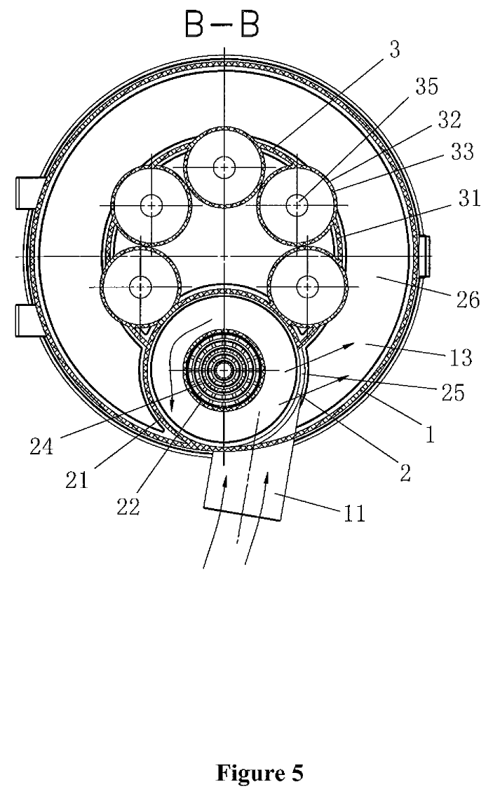

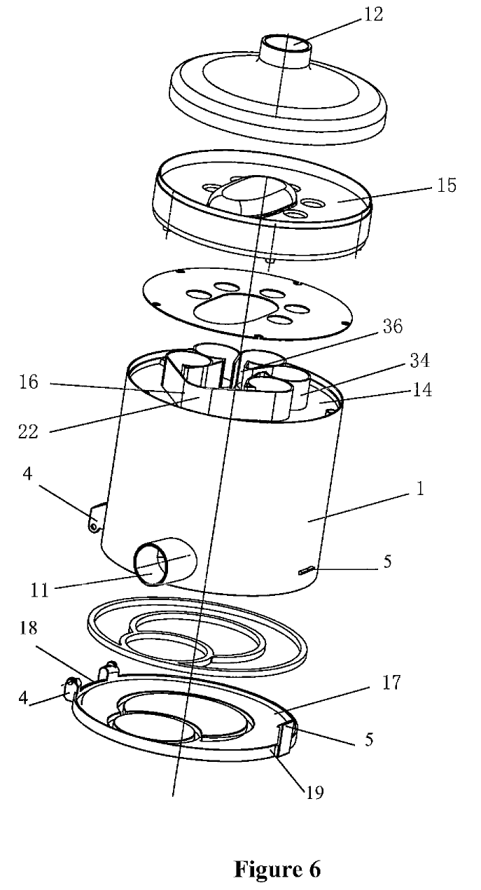

The first embodiment: with reference to FIGS. 1, 2, 3, 4, 5 and 6, a cyclonic separation device for vacuum cleaner comprising: a external barrel 1 having a main wind inlet 11 and a main wind outlet 12; a primary separator 2 and a secondary separator 3 in communication with each other both of which are located in the external barrel 1, and the primary separator 2 is connected to the main wind inlet 11 when the secondary separator 3 is connected to the main wind outlet 12;

from the top to the bottom, the external barrel 1 is divided into a separation chamber 13, a connection chamber 14 and an out-wind chamber 15; and the main wind inlet 11 is located at the lower portion of the separation chamber 13 while main wind outlet 12 is located on the top of the out-wind chamber 15;

the primary separator 2 includes a primary cyclonic barrel 21 located in the separation chamber 13, the main wind inlet 11 is connected with the primary cyclonic barrel 21 along its tangential direction; a primary wind outlet tube 22 located on the top portion of the primary cyclonic barrel 21 extends up into the connection chamber 14 and has a primary wind outlet 23 in the connection chamber 14; a conical filter barrier 24 is located on the lower end of the primary wind outlet tube 22 and a dust outlet 25 in communication with a primary dust collecting barrel 26 is located on the upper portion of the primary cyclonic barrel 21;

the secondary separator 3 includes a secondary dust collecting barrel 31 located in the separation chamber 13; several secondary cyclonic barrels 32 inserted paratactically in the upper portion of the secondary dust collecting barrel 31; the upper portion of secondary cyclonic barrel 32 extends into connection chamber 14 when the middle and lower portion is located in the separation chamber 13; a fallen-dust outlet 35 located in the secondary dust collecting barrel 31 is mounted on the bottom of the secondary cyclonic barrel 32; a secondary wind inlet 36 located on the top lateral of the secondary cyclonic barrel 32 is connected to the connection chamber 14 along the tangential direction; a secondary wind outlet tube 37 is coaxially mounted into the secondary cyclonic barrel 32, the upper slit of the wind outlet tube 37 is connected to the out-wind chamber 15;

the upper portion of several secondary cyclonic barrels 32 and the primary wind outlet tube 22 are mounted in enclosed shape in the connection chamber 14 and thus forms a divider 16; the secondary wind inlet 36 as well as the primary wind outlet 23 are located in the divider 16, and all the secondary wind inlets 36 face to the primary wind outlet 23;

the primary dust collecting barrel 26 and the secondary dust collecting barrel 31, as well as the external barrel 1, share a same bottom lid 17; one side 18 of the bottom lid is fixed on the side wall of the external barrel by a hinge assembly 4, and another side 19 of the bottom lid is fastened to the side wall of the external barrel 1 with a joggle assembly 5.

The the axis of the primary cyclonic barrel 21 is parallel to but dose not superposes to the axis of the secondary dust collecting barrel 31 as the primary cyclonic barrel 21 is partially embedded into the secondary dust collecting barrel 31; the circular room between the external wall of the primary cyclonic barrel 21 and the secondary dust collecting barrel 31 and the internal wall of the external barrel 1 forms the primary dust collecting barrel 26; several secondary cyclonic barrels 32 distribute axisymmetricly about the line crossing the centre of the circle of the primary cyclonic barrel 21 and the external barrel 1.

The lower portion of the secondary cyclonic barrel 32 is a inverted conical barrel 33 located in the separation chamber 13, while the upper portion of which is a columnar barrel 34 extending into the connection chamber 14; the fallen-dust outlet 35 is mounted on the bottom of the inverted conical barrel 33, the secondary wind inlet 36 is mounted on the sidewall of the columnar barrel 34 along its tangential direction, and the secondary wind outlet tube 37 is located in the columnar barrel 34.

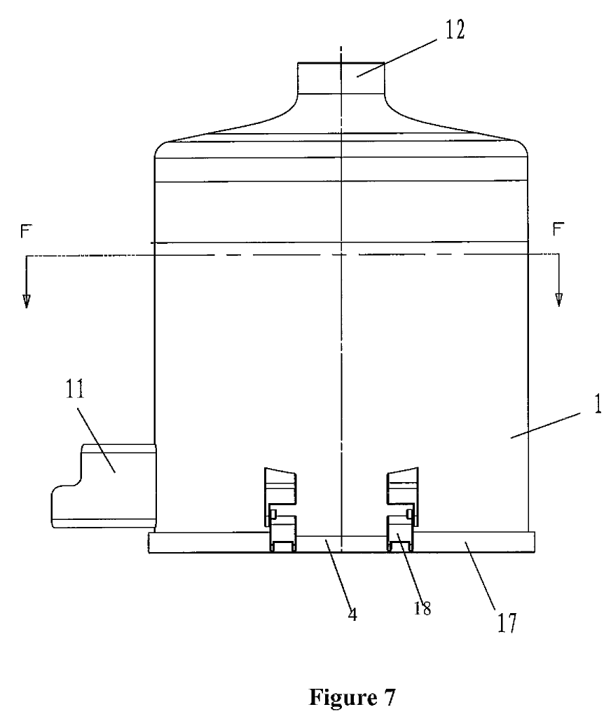

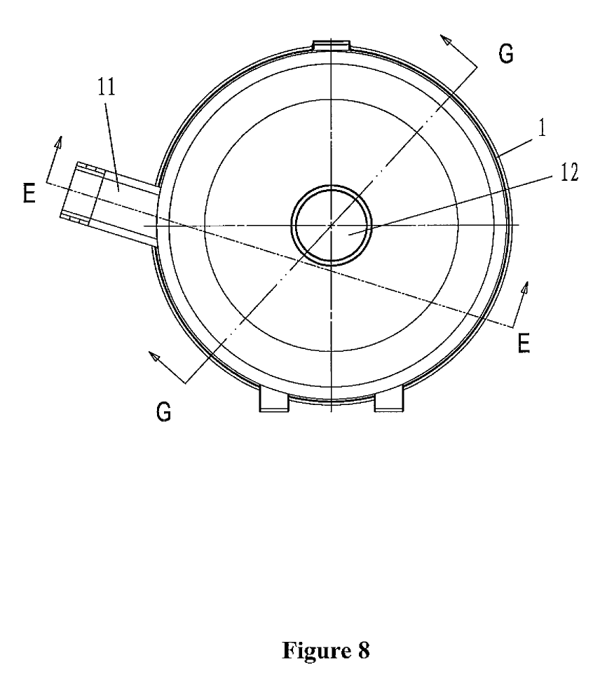

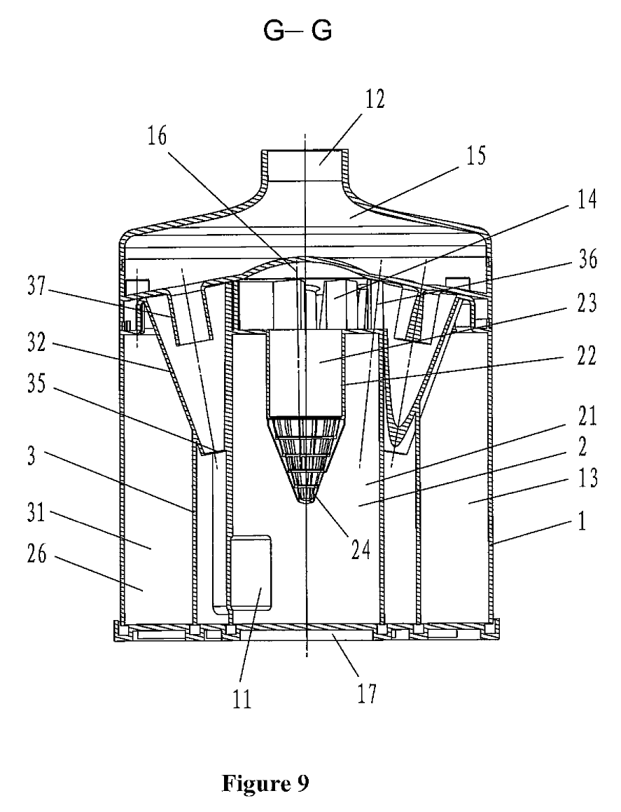

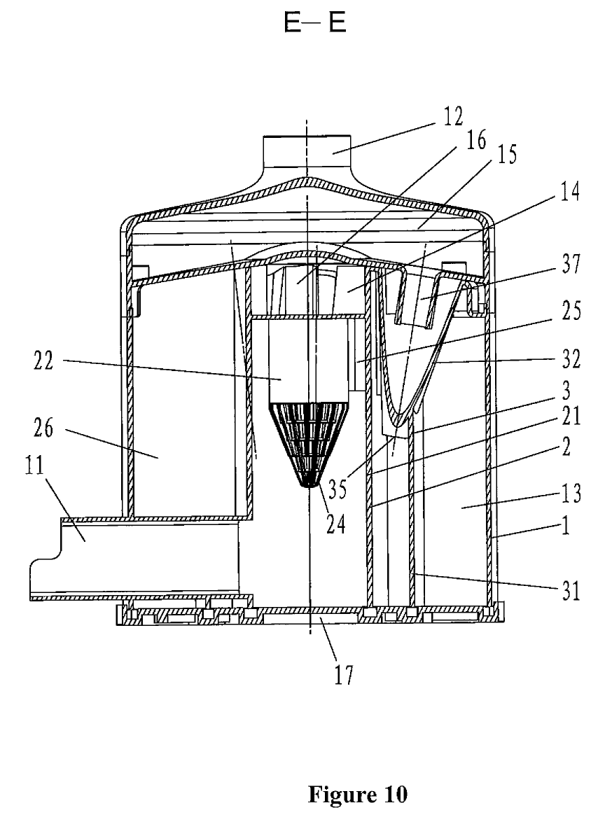

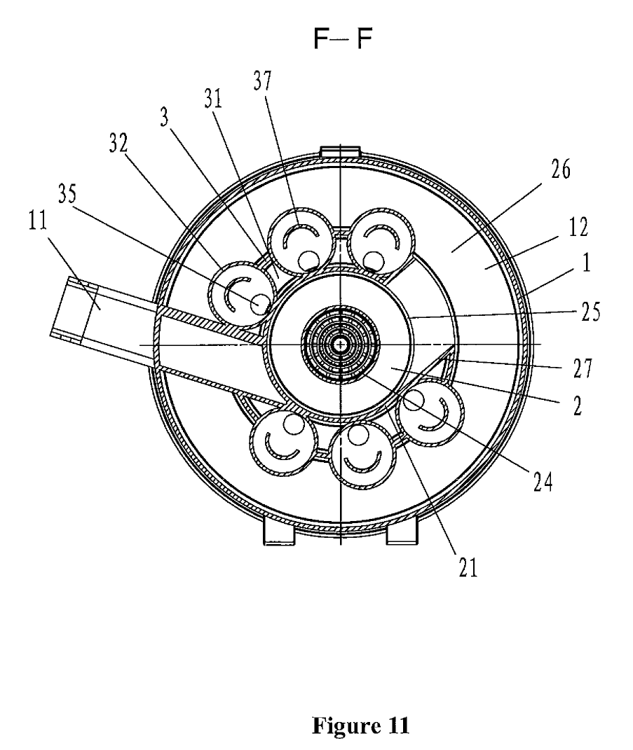

The second embodiment: with reference to FIGS. 7, 8, 9, 10 and 11, a cyclonic separation device for vacuum cleaner comprising: a external barrel 1 having a main wind inlet 11 and a main wind outlet 12; a primary separator 2 and a secondary separator 3 in communication with each other both of which are located in the external barrel 1, and the primary separator 2 is connected to the main wind inlet 11 when the secondary separator 3 is connected to the main wind outlet 12;

from the top to the bottom, the external barrel 1 is divided into a separation chamber 13, a connection chamber 14 and an out-wind chamber 15; and the main wind inlet 11 is located at the lower portion of the separation chamber 13 while main wind outlet 12 is located on the top of the out-wind chamber 15;

the primary separator 2 includes a primary cyclonic barrel 21 located in the separation chamber 13, the main wind inlet 11 is connected with the primary cyclonic barrel 21 along its tangential direction; a primary wind outlet tube 22 located on the top portion of the primary cyclonic barrel 21 extends up into the connection chamber 14 and has a primary wind outlet 23 in the connection chamber 14; a conical filter barrier 24 is located on the lower end of the primary wind outlet tube 22 and a dust outlet 25 in communication with a primary dust collecting barrel 26 is located on the upper portion of the primary cyclonic barrel 21; the secondary separator 3 includes a secondary dust collecting barrel 31 located in the separation chamber 13; several secondary cyclonic barrels 32 inserted paratactically in the upper portion of the secondary dust collecting barrel 31; the upper portion of secondary cyclonic barrel 32 extends into connection chamber 14 when the middle and lower portion is located in the separation chamber 13; a fallen-dust outlet 35 located in the secondary dust collecting barrel 31 is mounted on the bottom of the secondary cyclonic barrel 32; a secondary wind inlet 36 located on the top lateral of the secondary cyclonic barrel 32 is connected to the connection chamber 14 along the tangential direction; a secondary wind outlet tube 37 is coaxially mounted into the secondary cyclonic barrel 32, the upper slit of the wind outlet tube 37 is connected to the out-wind chamber 15;

the upper portion of several secondary cyclonic barrels 32 and the primary wind outlet tube 22 are mounted in enclosed shape in the connection chamber 14 and thus forms a divider 16; the secondary wind inlet 36 as well as the primary wind outlet 23 are located in the divider 16, and all the secondary wind inlets 36 face to the primary wind outlet 23;

the primary dust collecting barrel 26 and the secondary dust collecting barrel 31, as well as the external barrel 1, share a same bottom lid 17; one side 18 of the bottom lid is fixed on the side wall of the external barrel by a hinge assembly 4, and another side 19 of the bottom lid is fastened to the side wall of the external barrel 1 with a joggle assembly 5.

The primary cyclonic barrel 21, the secondary dust collecting barrel 31 and the external barrel 1 share a same axis; the primary cyclonic barrel 21 is covered within the secondary dust collecting barrel 31, and the room between them forms the primary dust collecting barrel 26; the dust outlet 25 located on upper portion of the primary cyclonic barrel 21 is connected with the dust outlet tube 27, and is in communication with the primary dust collecting barrel 26 by passing through the secondary dust collecting barrel 31; several secondary cyclonic barrels 32 are placed around a circle that centers on the axis of the secondary dust collecting barrel 31.

The lower portion of the secondary cyclonic barrel 32 is a inverted conical barrel 33 located in the separation chamber 13, while the upper portion of which is a columnar barrel 34 extending into the connection chamber 14; the fallen-dust outlet 35 is mounted on the bottom of the inverted conical barrel 33, the secondary wind inlet 36 is mounted on the sidewall of the columnar barrel 34 along its tangential direction, and the secondary wind outlet tube 37 is located in the columnar barrel 34.

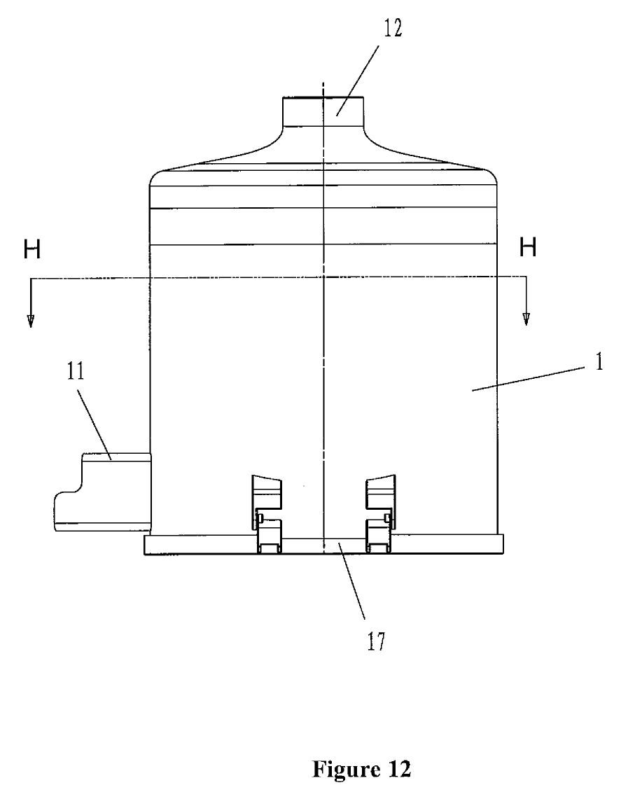

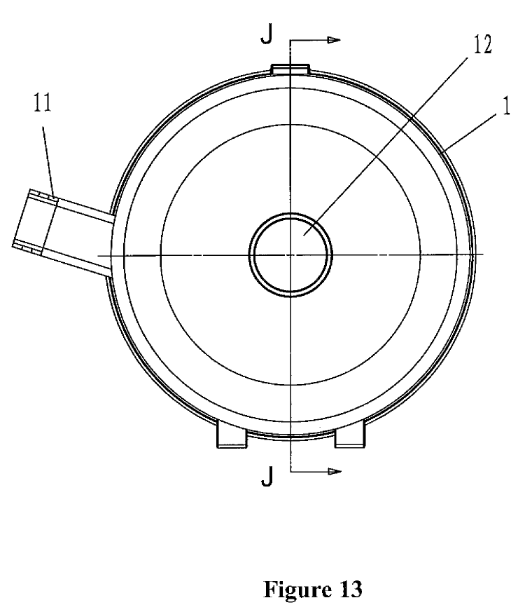

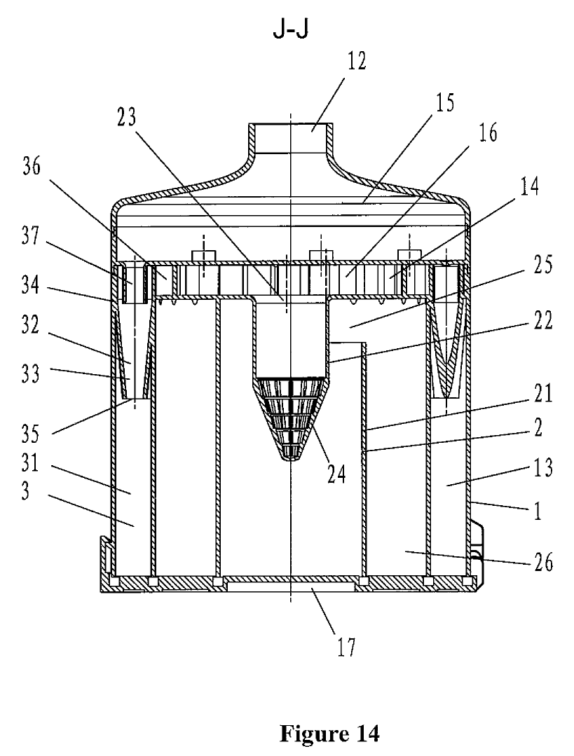

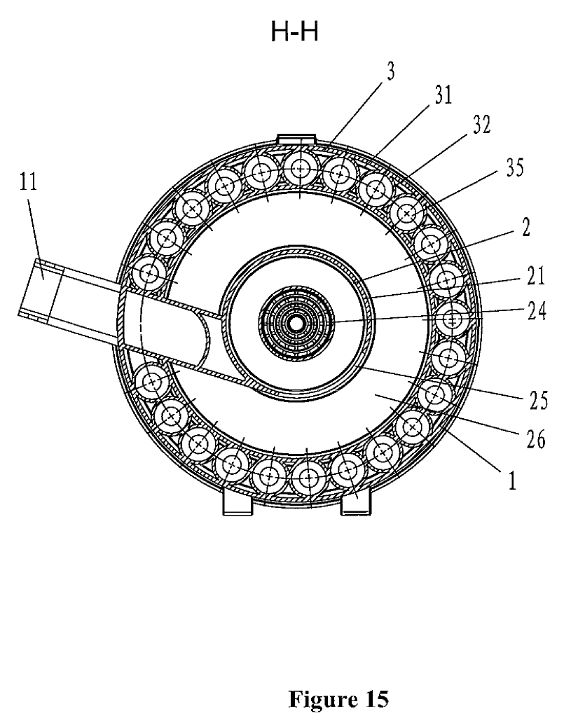

The third embodiment: with reference to FIGS. 12, 13, 14 and 15, a cyclonic separation device for vacuum cleaner comprising: a external barrel 1 having a main wind inlet 11 and a main wind outlet 12; a primary separator 2 and a secondary separator 3 in communication with each other both of which are located in the external barrel 1, and the primary separator 2 is connected to the main wind inlet 11 when the secondary separator 3 is connected to the main wind outlet 12;

from the top to the bottom, the external barrel 1 is divided into a separation chamber 13, a connection chamber 14 and an out-wind chamber 15; and the main wind inlet 11 is located at the lower portion of the separation chamber 13 while main wind outlet 12 is located on the top of the out-wind chamber 15;

the primary separator 2 includes a primary cyclonic barrel 21 located in the separation chamber 13, the main wind inlet 11 is connected with the primary cyclonic barrel 21 along its tangential direction; a primary wind outlet tube 22 located on the top portion of the primary cyclonic barrel 21 extends up into the connection chamber 14 and has a primary wind outlet 23 in the connection chamber 14; a conical filter barrier 24 is located on the lower end of the primary wind outlet tube 22 and a dust outlet 25 in communication with a primary dust collecting barrel 26 is located on the upper portion of the primary cyclonic barrel 21;

the secondary separator 3 includes a secondary dust collecting barrel 31 located in the separation chamber 13; several secondary cyclonic barrels 32 inserted paratactically in the upper portion of the secondary dust collecting barrel 31; the upper portion of secondary cyclonic barrel 32 extends into connection chamber 14 when the middle and lower portion is located in the separation chamber 13; a fallen-dust outlet 35 located in the secondary dust collecting barrel 31 is mounted on the bottom of the secondary cyclonic barrel 32; a secondary wind inlet 36 located on the top lateral of the secondary cyclonic barrel 32 is connected to the connection chamber 14 along the tangential direction; a secondary wind outlet tube 37 is coaxially mounted into the secondary cyclonic barrel 32, the upper slit of the wind outlet tube 37 is connected to the out-wind chamber 15;

the upper portion of several secondary cyclonic barrels 32 and the primary wind outlet tube 22 are mounted in enclosed shape in the connection chamber 14 and thus forms a divider 16; the secondary wind inlet 36 as well as the primary wind outlet 23 are located in the divider 16, and all the secondary wind inlets 36 face to the primary wind outlet 23;

the primary dust collecting barrel 26 and the secondary dust collecting barrel 31, as well as the external barrel 1, share a same bottom lid 17; one side of the bottom lid is fixed on the side wall of the external barrel by a hinge assembly, and another side of the bottom lid is fastened to the side wall of the external barrel 1 with a joggle assembly.

The primary cyclonic barrel 21, the secondary dust collecting barrel 31 and the external barrel 1 share a same axis; the primary cyclonic barrel 21 is set centrally and the secondary dust collecting barrels 31 are located peripherally, and the room between them forms the primary dust collecting barrel 26; several secondary cyclonic barrels 32 are placed around the circle that centers on the axis of the secondary dust collecting barrel 31.

The secondary cyclonic barrel 32 is a inverted conical barrel 33 with the fallen-dust outlet 35 mounted on its bottom, the lower portion of the inverted conical barrel 33 is located in separation chamber 13 while the upper portion extends into connection chamber 14.

During operation, the dust loaded air blow in from the main wind inlet 11 to the primary cyclonic barrel 21 of the primary separator 2 along the tangential direction, the coarse dust is stopped by the conical filter barrier 24 and goes in to the primary dust collecting barrel 26 through the dust outlet 25 or the dust outlet tube 26. The fine dust goes into the divider 16 through the primary wind outlet 23 of the primary wind outlet tube 22, and then goes into each secondary cyclonic barrel 32 via the secondary wind outlet 36. The fine dust drops down along the inverted conical barrel 33 and enters the secondary dust collecting barrel 31 via the fallen-dust outlet 35. The clean air enters the out-wind chamber 15 via the secondary wind outlet tube 37 and at last blows out from the main wind outlet 12.

Both filter and cyclonic separators are integrated in present invention: cyclonic filter device works as the primary separator and cyclonic separation device works as the secondary separator, which increases separation efficiency and reduces the volume of whole machine.

1. A cyclonic separation device for vacuum cleaner comprising: a external barrel (1) having a main wind inlet (11) and a main wind outlet (12); a primary separator (2) and a secondary separator (3) in communication with each other both of which are located in the external barrel (1), and the primary separator (2) is connected to the main wind inlet (11) when the secondary separator (3) is connected to the main wind outlet (12);
from the top to the bottom, the external barrel (1) is divided into a separation chamber (13), a connection chamber (14) and an out-wind chamber (15); and the main wind inlet (11) is located at the lower portion of the separation chamber (13) while main wind outlet (12) is located on the top of the out-wind chamber (15);
the primary separator (2) includes a primary cyclonic barrel (21) located in the separation chamber (13), the main wind inlet (11) is connected with the primary cyclonic barrel (21) along its tangential direction; a primary wind outlet tube (22) located on the top portion of the primary cyclonic barrel (21) extends up into the connection chamber (14) and has a primary wind outlet (23) in the connection chamber (14); a conical filter barrier (24) is located on the lower end of the primary wind outlet tube (22) and a dust outlet (25) in communication with a primary dust collecting barrel (26) is located on the upper portion of the primary cyclonic barrel (21);
the secondary separator (3) includes a secondary dust collecting barrel (31) located in the separation chamber (13); several secondary cyclonic barrels (32) inserted paratactically in the upper portion of the secondary dust collecting barrel (31); the upper portion of secondary cyclonic barrel (32) extends into connection chamber (14) when the middle and lower portion is located in the separation chamber (13); a fallen-dust outlet (35) located in the secondary dust collecting barrel (31) is mounted on the bottom of the secondary cyclonic barrel (32); a secondary wind inlet (36) located on the top lateral of the secondary cyclonic barrel (32) is connected to the connection chamber (14) along the tangential direction; a secondary wind outlet tube (37) is coaxially mounted into the secondary cyclonic barrel (32), the upper slit of the wind outlet tube (37) is connected to the out-wind chamber (15);
the upper portion of several secondary cyclonic barrels (32) and the primary wind outlet tube (22) are mounted in enclosed shape in the connection chamber (14) and thus forms a divider (16); the secondary wind inlet (36) as well as the primary wind outlet (23) are located in the divider (16), and all the secondary wind inlets (36) face to the primary wind outlet (23);
the primary dust collecting barrel (26) and the secondary dust collecting barrel (31), as well as the external barrel (1), share a same bottom lid (17); one side (18) of the bottom lid is fixed on the side wall of the external barrel by a hinge assembly (4), and another side (19) of the bottom lid is fastened to the side wall of the external barrel (1) with a joggle assembly (5).

2. The cyclonic separation device as claimed in claim 1, wherein the axis of the primary cyclonic barrel (21) is parallel to but dose not superposes to the axis of the secondary dust collecting barrel (31) as the primary cyclonic barrel (21) is partially embedded into the secondary dust collecting barrel (31); the circular room between the external wall of the primary cyclonic barrel (21) and the secondary dust collecting barrel (31) and the internal wall of the external barrel (1) forms the primary dust collecting barrel (26); several secondary cyclonic barrels (32) distribute axisymmetricly about the line crossing the centre of the circle of the primary cyclonic barrel (21) and the external barrel (1).

3. The cyclonic separation device as claimed in claim 1, wherein the primary cyclonic barrel (21), the secondary dust collecting barrel (31) and the external barrel (1) share a same axis; the primary cyclonic barrel (21) is covered within the secondary dust collecting barrel (31), and the room between them forms the primary dust collecting barrel (26); the dust outlet (25) located on upper portion of the primary cyclonic barrel (21) is connected with the dust outlet tube (27), and is in communication with the primary dust collecting barrel (26) by passing through the secondary dust collecting barrel (31); several secondary cyclonic barrels (32) are placed around a circle that centers on the axis of the secondary dust collecting barrel (31).

4. The cyclonic separation device as claimed in claim 1, wherein the primary cyclonic barrel (21), the secondary dust collecting barrel (31) and the external barrel (1) share a same axis; the primary cyclonic barrel (21) is set centrally and the secondary dust collecting barrels (31) are located peripherally, and the room between them forms the primary dust collecting barrel (26); several secondary cyclonic barrels (32) are placed around the circle that centers on the axis of the secondary dust collecting barrel (31).

5. The cyclonic separation device as claimed in claim 2, wherein the lower portion of the secondary cyclonic barrel (32) is a inverted conical barrel (33) located in the separation chamber (13), while the upper portion of which is a columnar barrel (34) extending into the connection chamber (14); the fallen-dust outlet (35) is mounted on the bottom of the inverted conical barrel (33), the secondary wind inlet (36) is mounted on the sidewall of the columnar barrel (34) along its tangential direction, and the secondary wind outlet tube (37) is located in the columnar barrel (34).

6. The cyclonic separation device as claimed in claim 3, wherein the secondary cyclonic barrel (32) is a inverted conical barrel (33) with the fallen-dust outlet (35) mounted on its bottom, the lower portion of the inverted conical barrel (33) is located in separation chamber (13) while the upper portion extends into connection chamber (14).

7. The cyclonic separation device as claimed in claim 4, wherein the lower portion of the secondary cyclonic barrel (32) is a inverted conical barrel (33) located in the separation chamber (13), while the upper portion of which is a columnar barrel (34) extending into the connection chamber (14); the fallen-dust outlet (35) is mounted on the bottom of the inverted conical barrel (33), the secondary wind inlet (36) is mounted on the sidewall of the columnar barrel (34) along its tangential direction, and the secondary wind outlet tube (37) is located in the columnar barrel (34).
